(19) United States
(12) Patent Application Publication
(10) Pub. No.: US 2023/0304903 A1
(43) Pub. Date: Sep. 28, 2023

(54) PARTICLE COLLECTING DEVICE HAVING A CLEANING UNIT, AND CLEANING METHOD FOR A PARTICLE COLLECTING DEVICE

(71) Applicant: CLEANCONTROLLING GMBH, Emmingen-Liptingen (DE)

(72) Inventor: Volker Burger, Emmingen-Liptingen (DE)

(73) Assignee: CLEANCONTROLLING GMBH, Emmingen-Liptingen (DE)

(21) Appl. No.: 18/022,225

(22) PCT Filed: May 31, 2021
(86) PCT No.: PCT/EP2021/064509

§ 371 Date: Feb. 20, 2023

(30) Foreign Application Priority Data
Aug. 20, 2020 (DE) 10 2020 121 888.5

(51) Int. Cl. G01N 1/22; G01N 1/24; G01N 15/06

(52) U.S. Cl. CPC G01N 1/2205; G01N 1/24; G01N 15/0618; G01N 2001/242

(57) ABSTRACT

A particle collecting device for collecting particles from surfaces for a particle analysis within the context of testing the technical cleanliness of test bodies, in particular work pieces and machines, with a cleaning unit.

### BACKGROUND OF THE INVENTION

The invention relates to a particle collecting for collecting particles from surfaces for a particle analysis when testing the technical cleanliness of test objects, in particular work pieces, machines and/or printed circuit boards, in a suction mode using a cleaning unit. Furthermore, the present invention relates to a cleaning method for cleaning a particle collecting device.

Particle collecting devices for detecting and documenting the technical cleanliness of test objects are generally known from the state of the art. The known particle collecting devices comprise a suction line for aspirating a particle/air mixture from the surface to be tested on the test object. Before reaching a vacuum source, the aspirated particle/air mixture flows through a particle collection so that the particles are filtered out of the particle/air mixture before reaching the vacuum source.

An optical analysis of the particles filtered out in the particle collection unit with regard to their number, size and/or quality permits assessing the technical cleanliness of the test object and drawing conclusions as to the technical cleanliness of the production site.

The known particle collecting devices are disadvantageous in that the aspirated particles form deposits which can stick to the inside of the suction line and/or the particle collection unit in suction mode. If these deposited particles come off during a measurement (testing of the technical cleanliness) of the particle collecting device, this has a negative impact on the test result and/or distorts the test result.

For this reason, it has been known from applicant's DE 10 2018110 320 A1 for a cloth soaked in ethanol and used in combination with a rod-shaped holding element to be used for cleaning the suction line when cleaning a generic particle collecting device. The known solution is disadvantageous since it takes a relatively long time, which must be spent by an appropriately trained operator to clean the suction line and the particle collection unit. Nevertheless, the cleaning effect is usually not sufficient since the cloth cannot remove all deposited particles.

### SUMMARY OF THE INVENTION

Based on the aforementioned state of the art, the object of the present invention is to overcome the disadvantages known from the state of the art. In particular, the object of the present invention is to provide a particle collecting device having a cleaning unit in order to clean a generic particle collecting device as thoroughly as possible in the least possible amount of time (in a time-efficient manner) so as to avoid a negative impact on and/or a falsification of the determination of the technical cleanliness of different measurements (tests).

With regard to the particle collecting device, this object is attained by the features disclosed herein.

Furthermore, this object is attained by a cleaning method as disclosed herein.

The invention is based on the idea of cleaning a generic particle collecting device for collecting particles from surfaces of a test object in a suction mode of the particle collecting device for a particle analysis when testing the technical cleanliness of test objects, in particular work pieces, machines and/or printed circuit boards, with a cleaning liquid using a cleaning unit according to the invention in a rinsing mode. The particle collecting device comprises a suction line configured for aspirating a particle/air mixture from the surface to be tested on the test object. Before reaching a vacuum source, the particle/air mixture flows through a particle collection unit for filtering out the particles, which are then evaluated in a subsequent and/or independent step, in particular by means of optical analysis means, in order to determine the technical cleanliness.

In the context of the present invention, the particle collecting device comprises the cleaning unit, which is configured to the effect that the particle collecting device, that is, in particular the modules transporting the particle/air mixture, specifically the suction line and the particle collection unit, can be rinsed in such a manner aspirating the cleaning liquid in rinsing mode of the particle collecting device that stuck and/or deposited particles can be flushed out and/or washed out of the particle collecting device, in particular the suction line and the particle collection unit.

Preferably, an aqueous solution, particularly preferably demineralized water, is used as the cleaning liquid. Advantageously, the particle collecting device configured according to the invention allows automatic cleaning, the vacuum source of the particle collecting device, i.e., the ability of the particle collecting device of aspirating an air mixture or a fluid mixture, also being advantageously used for the cleaning according to the invention since a cleaning liquid is now aspirated instead of the particle/air mixture in suction mode of the particle collecting device. Advantageously, the cleaning liquid flows through the entire particle collecting device, which is why the cleaning according to the invention proves highly thorough and is additionally time-efficient.

Advantageous embodiments of the invention are indicated in the dependent claims. Any and all combinations of at least two of the features disclosed in the description, the claims and/or the figures fall within the scope of the invention. Furthermore, features disclosed in the context of the device shall also be claimable in the context of the method and vice-versa.

According to an embodiment of the present invention, the particle collecting device comprises a total of two particle collection units. In this context, the first particle collection unit is preferably a filter holder, which serves to hold an exchangeable analysis filter, or alternatively a centrifugal separator (cyclone). The centrifugal separator can be used to filter out the particles aspirated by the suction line in suction mode of the particle collecting device from the particle/air mixture by forming a cyclone since a centrifugal force acts on the particles because of the weight force.

Furthermore, the second particle collection unit of the particle collecting device is preferably a filter holder, and, as stated above, the filter holder is configured to hold an exchangeable analysis filter in order to filter out the particles of the particle/air mixture on a particle collection surface of the analysis filter when the particle/air mixture flows through the analysis filter.

Advantageously, a two-stage filter in the particle collecting device, which is in particular formed by a centrifugal separator and the filter holder, which is disposed behind the former in a suction-air-conducting manner, allows the measuring and/or testing time (time interval or measuring timespan) of the particle collecting device to be extended compared to a single-stage filter since in particular larger particles, on which a greater centrifugal force acts, can be filtered out in the centrifugal separator and smaller particles can be filtered out of the particle/air mixture when it flows through the analysis filter as a function of a selected pore density of the analysis filter. In this context, especially, the configuration of the particle collecting device according to the invention with the cleaning unit is particularly advantageous since all particle collection units can be rinsed during the aspiration of the cleaning liquid. Compared to the state of the art, this makes it possible for time having to be spent cleaning by an operator to be saved.

According to an embodiment, the centrifugal separator is connected to the suction line in a suction-air-conducting manner; in suction mode of the particle collecting device, the aspirated particle/air mixture rotates in the centrifugal separator, the particles thus being flung against a wall of the centrifugal separator, which decelerates them and separates them from the particle/air mixture, which in particular flows out through an immersion tube in an upward direction. Furthermore, the centrifugal separator preferably has a seat at its underside, the seat being in particular a threaded connection and being configured in such a manner that a collecting vessel for collecting the separated particles trickling out of the centrifugal separator can be disposed at the underside of the centrifugal separator; the collecting vessel can in particular be detached from the centrifugal separator for carrying out an optical analysis of the particles.

According to an embodiment in this context, the centrifugal separator further comprises a vertically oriented immersion tube to which a vacuum supply line is connected in such a manner that the aspirated fluid (air mixture or cleaning liquid) flows through the vacuum supply line to the vacuum source in suction mode and in rinsing mode, the aspirated fluid flowing through the filter holder before reaching the vacuum source.

According to an embodiment, the suction line can be detached from the centrifugal separator. Furthermore, the vacuum supply line is detachable at least from the filter holder in this context, the suction line being configured in such a manner that it can be replaced with the vacuum supply line. Advantageously, this allows the suction line to be connected to the filter holder in a suction-air-conducting manner, in which case a suction mode and/or a rinsing mode of the particle collecting device can also be implemented with only a filter holder when such a configuration of the particle collecting device according to the invention is chosen. So the centrifugal separator is bypassed in a suction-air-conducting manner in such a mode in order to measure a test of the technical cleanliness of test objects comprising few and/or only small particles, for example, using only the filter holder as a particle collection unit and/or to implement the rinsing mode.

According to another embodiment, the cleaning unit comprises a liquid storage unit which is configured to provide a cleaning liquid, in particular water, an aqueous solution or demineralized water, and which is preferably configured and/or dimensioned in such a manner that it is detachable from the particle collecting device or even as a component that is separate or autonomous from the particle collecting device. In this context, the liquid storage unit further preferably has a total storage capacity of 5 l, preferably 3 l, particularly preferably 2 l, most preferably 1 l. Advantageously, the rinsing mode can thus be implemented in any location of the particle collecting device (measuring site) since the liquid storage unit makes the cleaning liquid accessible at all times.

According to another preferred embodiment, the liquid storage unit is in operative connection with the suction line in such a manner that the cleaning liquid can be aspirated by means of the suction line in rinsing mode. Advantageously, the normal operation and/or the normal functioning of the particle collecting device in suction mode can also be used for cleaning (implementing the rinsing mode of) the particle collecting device since the cleaning liquid can now be aspirated through the suction line instead of a particle/air mixture in order to thus clean the suction line and the first and/or the second particle collection unit by making the cleaning liquid flow through them so as to flush deposits of particles out of the particle collecting device.

According to an embodiment of the present invention, the cleaning unit comprises an adapter unit configured to be connected to the centrifugal separator in a detachable manner. To this end, the seat of the centrifugal separator is preferably used to replace the collecting vessel with the adapter unit so as to bring the latter in operative contact with the centrifugal separator and/or the particle collecting device. Advantageously, the adapter unit can be used to influence the centrifugal separator, which forms a vat because of the immersion tube ending in the middle thereof, the cleaning liquid accumulating in said vat in rinsing mode.

According to a preferred embodiment in this context, the adapter unit has a switchable valve, the valve being disposed in a connecting hose, the connecting hose being in fluid-conducting operative connection with the adapter unit at one end, and the valve being switchable between a fluid-conducting state and a fluid-blocking state. Advantageously, the function of the connecting hose and thus the function of the adapter unit can be influenced via the switching state of the valve, in particular in order to discharge cleaning fluid backed up in the centrifugal separator when the valve is in the fluid-conducting state.

Furthermore, the connecting hose additionally forms a fluid-conducting channel section between the centrifugal separator and the vacuum source, in particular the filter holder, when the valve is in the fluid-conducting state; in particular, the valve is switched to the fluid-blocking state in rinsing mode. Advantageously, such a configuration allows aspirating the cleaning liquid in the event that the valve is switched to the fluid-conducting state since the free end of the connecting hose is in operative connection with the vacuum source.

According to another configuration of the cleaning unit, it has a membrane suction end portion configured to the effect that it can be connected to an end portion of the suction line in a suction-air-conducting manner; in a connected state of the membrane suction end portion, the suction line can aspirate (pure) air only. Specifically, this is the case since a suction opening of the suction line is completely covered by an air-permeable membrane of the membrane suction end portion when the membrane suction end portion is plugged onto and/or connected to the suction line in a suction-air-conducting manner. Advantageously, this allows the implementation of a preferred dry mode, in which an air mixture can be aspirated by activating the vacuum source, the air-permeable membrane ensuring that no particles are aspirated from the environment.

Advantageously, this allows fluid residue in the particle collecting device to be removed and/or discharged. Preferably, the valve is also switched to the fluid-conducting state in dry mode in order to thus discharge fluid backed up in the centrifugal separator. It is noted once more that the membrane suction end portion either is not connected to the suction line in a suction-air-conducting manner in rinsing mode or can be bypassed in a suction-air-conducting manner via a parallel channel section.

According to another preferred configuration of the particle collecting device, the particle collecting device comprises control means configured to the effect that in rinsing mode, the valve is switched to the fluid-blocking state and the cleaning liquid, in particular 11 of the cleaning liquid, can be aspirated from the liquid storage unit through the suction line for rinsing the particle collecting device, in particular the modules transporting the particle/air mixture, in particular the suction line, the centrifugal separator, which comprises the immersion tube, the vacuum supply line and/or the filter holder, and that in dry mode, the valve is switched to the fluid-conducting state and the suction line can aspirate air through the membrane suction end portion.

Moreover, the present invention also relates to a cleaning method for cleaning a particle collecting device for collecting particles from surfaces for a particle analysis when testing the technical cleanliness of test objects, in particular work pieces, machines and/or printed circuit boards, the method comprising the following steps:

In a first step, a cleaning unit is brought in operative contact with the particle collecting device. Subsequently, a rinsing mode of the particle collecting device is activated, a suction line of the particle collecting device for aspirating a particle/air mixture in suction mode and a particle collection unit for filtering out the particles of the particle/air mixture in suction mode being rinsed by aspirating a cleaning liquid in order to flush residue of particles and/or deposited particles out of the particle collecting device.

According to an embodiment in this context, a centrifugal separator of the particle collecting device and/or a filter holder of the particle collecting device are rinsed with the cleaning liquid in order to flush out the stuck particles.

Furthermore, the present invention relates to a method comprising the following steps.

In a first step, an exchangeable analysis filter is removed from the filter holder. Then, the suction line is immersed in a liquid storage unit containing a cleaning liquid in order to aspirate the cleaning liquid using the suction line in a rinsing mode. In another step, an adapter unit is brought into operative contact with the centrifugal separator by means of a seat of the centrifugal separator. Moreover, a free end of a connecting hose, which is coupled to the adapter unit in a fluid-conducting manner at the other end, is brought into operative contact with the vacuum source, in particular with the filter holder. Moreover, a valve disposed in the connecting hose is switched into a fluid-blocking state.

In a subsequent step, the rinsing mode of the particle collecting device is activated, the cleaning liquid being aspirated through the suction line and flowing into the centrifugal separator, from where it partially flows through the filter holder via the immersion tube and the vacuum supply line. After the aspiration of the cleaning liquid, in particular 1 l of the cleaning liquid, the rinsing mode is deactivated by deactivating the vacuum source.

Subsequently, a membrane suction end portion is connected to the suction line so that the suction line can aspirate air only through the air-permeable membrane of the membrane suction end portion. In another step, the valve is switched to the fluid-conducting state before the dry mode for suctioning fluid residue out of the particle collecting device is activated by activating the suction mode of the particle collecting device in order to pump fluid residue from the particle collecting device and in particular from the centrifugal separator, which forms a vat, via the connecting hose. Finally, the dry mode is deactivated.

According to another embodiment, the cleaning method is used to clean a particle collecting device according to the invention.

### BRIEF DESCRIPTION OF THE DRAWINGS

Other advantages, features and details of the invention are apparent from the following description of preferred exemplary embodiments and from the drawings.

FIG. 1a, FIG. 1b: are schematic illustrations of a preferred embodiment of the particle collecting device according to the invention, which comprises a cleaning unit for rinsing particle residue from the particle collecting device; and

FIG. 2a, FIG. 2b: are additional schematic illustrations of the particle collecting device from FIGS. 1a/b, cleaning now being carried out using only the suction line and the filter holder.

### DETAILED DESCRIPTION

In the Figures, identical elements and elements having the same function are labeled with the same reference signs.

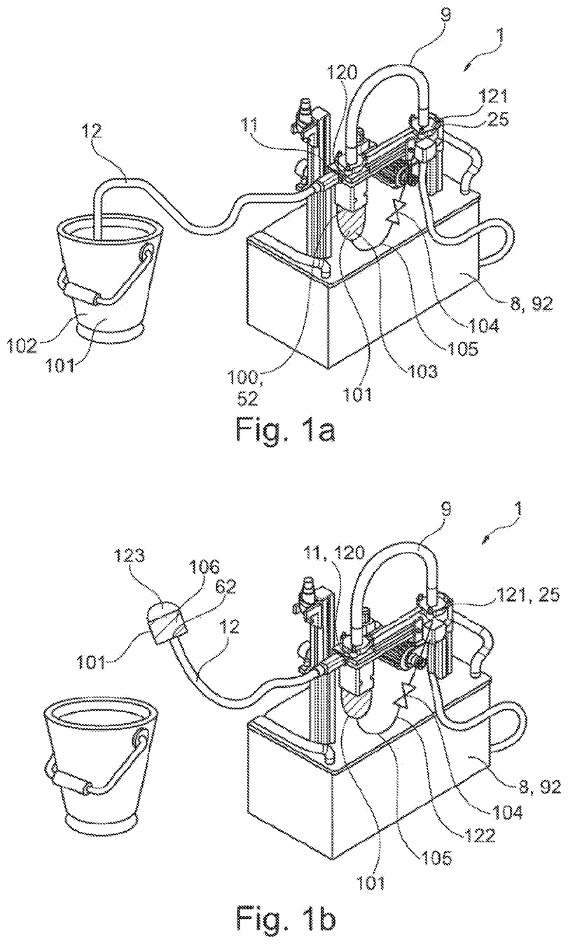

FIG. 1a shows a schematic illustration of a particle collecting device 1 for collecting particles from surfaces for a particle analysis when testing the technical cleanliness of test objects, in particular work pieces, machines and/or printed circuit boards, according to a preferred embodiment of the present invention.

Illustrated particle collecting device 1 comprises a cleaning unit 101, which is in operative contact with particle collecting device 1. Particle collecting device 1 comprises a first particle collection unit 120, which is a centrifugal separator 11, and a second particle collection unit 121, which is a filter holder 25, for a suction mode for aspirating a particle/air mixture from the surface of the test object. Filter holder 25 is configured for accommodating an exchangeable analysis filter; in suction mode, the particle/air mixture flows through the analysis filter before reaching a vacuum source 8 in order to deposit the particles on a particle collecting surface formed by the analysis filter.

Furthermore, cleaning unit 101 comprises an adapter unit 103, which is in operative contact with centrifugal separator 11 via a seat 100, which is a threaded connection 52. Adapter unit 103 comprises a connecting hose 105, which is schematically illustrated in the Figures and has a switchable valve 104, which can be switched between a fluid-conducting state and a fluid-blocking state. Connecting hose 105 is in fluid-conducting contact not only with adapter unit 103 but also with filter holder 25, which is why connecting hose 105 is in operative connection with vacuum source 8; in the case at hand, vacuum source 8 is formed by a wet vacuum cleaner 92.

Furthermore, illustrated cleaning unit 101 comprises a liquid storage unit 102, which is schematically illustrated in the Figures as a bucket, which contains a cleaning liquid for implementing the rinsing mode according to the invention.

When cleaning particle collecting device 1, suction line 12 is first immersed in the cleaning liquid of liquid storage unit 102. Then, valve 104 is switched into the fluid-blocking state to ensure that no cleaning liquid can flow via connecting hose 105.

Subsequently, the rinsing mode of particle collecting device 1 is activated by activating vacuum source 8; in the present embodiment of particle collecting device 1 according to the invention, vacuum source 8 is formed by a vacuum cleaner 92, as mentioned above. Switching on vacuum cleaner 92 causes suction line 12 to aspirate the cleaning liquid, which flows into centrifugal separator 11, from where it flows through filter holder 25, which does not comprise an analysis filter, via immersion tube 22 and the vacuum supply line.

Advantageously, the cleaning liquid flushes stuck and/or deposited particles out of the particle collecting device. After flowing through vacuum supply line 9 and filter holder 25, the cleaning liquid is collected in a storage unit (not shown) of vacuum cleaner 92.

Furthermore, various tests and measurements have shown that the advantageous use of adapter unit 103 makes a total amount of approximately 1 l of cleaning liquid sufficient in order to fully clean particle collecting device 1. In this context, it is to be advantageously noted that this means that multiple rinsing processes can be carried out for cleaning particle collecting device 1 before the storage unit formed by vacuum cleaner 92 is completely filled with the cleaning liquid. As a result, the rinsing mode can advantageously be implemented multiple times at any location between tests for determining the technical cleanliness.

After implementing the rinsing mode of particle collecting device 1, a dry mode of particle collecting device 1 is implemented, which is schematically illustrated in FIG. 1b.

For implementing the dry mode, which preferably follows immediately after the rinsing mode, vacuum cleaner 92 has to be deactivated first in order to end the suction mode or the rinsing mode. Then, a membrane suction end portion 106 is connected to the end of suction line 12 in such a manner that suction opening 62 of suction line 12 is completely covered by an air-permeable membrane 123 of membrane suction end portion 106.

After membrane suction end portion 106 has been connected in a suction-air-conducting manner, valve 104 is switched to the fluid-conducting state. Then, vacuum cleaner 92 is turned on to activate vacuum source 8.

Finely porous membrane 123 of membrane suction end portion 106 ensures that pure air only is aspirated by suction line 12 in dry mode of particle collecting device 1 since no additional particles can be aspirated from the environment through membrane 123. Furthermore, valve 104 of connecting hose 105 is switched to the fluid-conducting state in dry mode in order to form a fluid-conducting channel section 122. This has the result that cleaning liquid can also be suctioned off through connecting hose 105 in order to fully discharge the cleaning liquid backed up in centrifugal separator 11 because of the constructive design. In addition to the cleaning liquid backed up in centrifugal separator 11, any fluid residue is also discharged from particle collecting device 1 in dry mode, which is why a new suction mode for determining the technical cleanliness can be implemented immediately after ending the dry mode of particle collecting device 1 without the risk of humid particle clumps forming in particle collecting device 1 because of liquid residue.

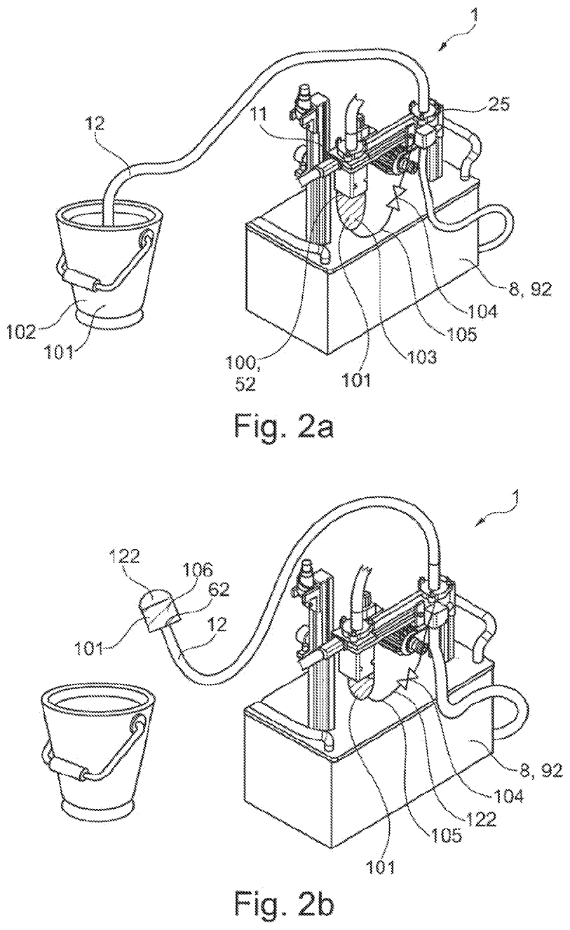

FIGS. 2a and 2b show the particle collecting device 1 known from FIGS. 1a and 1 b, only suction line 12 and filter holder 25 being cleaned. Such a cleaning is advantageous whenever surfaces with few and/or small particles have been analyzed before since centrifugal separator 11, which is intended for filtering out large particles, is bypassed in a suction-air-conducting manner in suction mode in this case by connecting suction line 12 directly to filter holder 25 in a suction-air-conducting manner and not to centrifugal separator 11.

In this case, too, cleaning initially takes place in a rinsing mode, which is schematically illustrated in FIG. 2a and in which cleaning liquid is aspirated from a liquid storage unit 102 via suction line 12.

After implementing the rinsing mode, suction line 12 is also connected to membrane suction end portion 106, as schematically illustrated in FIG. 2b, in order to prevent a continued aspiration of particles from the environment in the subsequent dry mode.

As a result, the present invention allows a generic particle collecting device 1 to be cleaned thoroughly and quickly in a surprisingly simple manner; also, multiple cleanings of the particle collecting device can be carried out between measurements for determining the technical cleanliness in field use or in the case of an autarkic operation of particle collecting device 1.

### REFERENCE SIGNS

1 particle collecting device
8 vacuum source
9 vacuum supply line
11 centrifugal separator
12 suction line
22 immersion tube
25 filter holder
52 threaded connection
62 suction opening
92 vacuum cleaner
100 seat
101 cleaning unit
102 liquid storage unit
103 adapter unit
104 valve
105 connecting hose
106 membrane suction end portion
123 air-permeable membrane

1. A particle collecting device (1) for collecting particles from surfaces for a particle analysis when testing the technical cleanliness of test objects in a suction mode of the particle collecting device (1), the particle collecting device (1) comprising:
a suction line (12) configured for aspirating a particle/air mixture from a surface to be tested; and
a particle collection unit (120) configured to filter out aspirated particles of the particle/air mixture before it reaches a vacuum source (8),
wherein
the particle collecting device (1) comprises a cleaning unit (101) configured in such a manner that the particle collecting device (1) can be rinsed in a rinsing mode of the particle collecting device (1) by aspirating a cleaning liquid, in order to flush out particles accumulated during suction mode.

2. The particle collecting device according to claim 1,
wherein
the particle collecting device (1) comprises a second particle collection unit (121) for collecting the particles, the first particle collection unit (120) being a filter holder (25) or a centrifugal separator (11), and the second particle collection unit (121) being a filter holder (25), and the filter holder (25) being configured to hold an exchangeable analysis filter.

3. The particle collecting device according to claim 2,
wherein
the suction line (12) for aspirating the particle/air mixture from the surface to be tested is connected to the centrifugal separator (11) in such a manner that the aspirated particle/air mixture rotates in the centrifugal separator (11) and the particles can be flung against a wall and thus be separated in suction mode,
the centrifugal separator (11) comprising a seat (100) for attaching a collecting vessel (17) for collecting the separated particles in a detachable manner,
and wherein the centrifugal separator (11) comprises an immersion tube (22) to which a vacuum supply line (9) is connected in such a manner that the air suctioned out of the centrifugal separator (11) and flowing through the vacuum supply line (9) in suction mode flows through the analysis filter, which is disposed in the filter holder (25) and serves to retain the particles on a particle collecting surface of the analysis filter, before reaching the vacuum source (8).

4. The particle collecting device according to claim 3,
wherein
the suction line (12) is connected to the centrifugal separator (11) in a detachable manner, and the vacuum supply line (9) is connected to the filter holder (25) in a detachable manner, the suction line (12) being configured in such a manner that it can be replaced with the vacuum supply line (9) in order to implement the rinsing mode while the centrifugal separator (11) is bypassed in a fluid-conducting manner.

5. The particle collecting device according to claim 1, wherein
the cleaning unit (101) comprises a liquid storage unit (102) configured to provide a cleaning liquid which is detachable or a separate component from the particle collecting device (1), and/or
the liquid storage unit (102) has a storage capacity of 5 l.

6. The particle collecting device according to claim 5,
wherein
the liquid storage unit (102) is in operative connection with the suction line (12) in such a manner that the cleaning liquid can be aspirated by means of the suction line (12) in rinsing mode.

7. The particle collecting device according to claim 3,
wherein
the cleaning unit (101) comprises an adapter unit (103) configured for being connected to the centrifugal separator (11) in a detachable manner via the seat (100) for exchanging the collecting vessel (17) attached to the centrifugal separator (11) in a detachable manner.

8. The particle collecting device according to claim 7,
wherein
the adapter unit (103) comprises a connecting hose (105) having a switchable valve (104), the valve (104) being switchable between a fluid-conducting state and a fluid-blocking state.

9. The particle collecting device according to claim 8,
wherein
the connecting hose (105) forms a fluid-conducting channel section (122) between the centrifugal separator (11) and the vacuum source (8) when the valve (104) is in the fluid-conducting state, the valve (104) being switched to the fluid-blocking state in rinsing mode.

10. The particle collecting device according to claim 1,
wherein
the cleaning unit (101) comprises a membrane suction end portion (106) configured to be connected to the suction line (12) in a suction-air-conducting manner when in a connected state, a suction opening (62) formed by the suction line (12) and serving to aspirate the particle/air mixture being covered by an air-permeable membrane (123) in the connected state for aspirating a pure air mixture, which contains no particles.

11. The particle collecting device according to claim 10,
wherein
the particle collecting device (1) comprises a dry mode in addition to the rinsing mode, the membrane suction end portion (106) being connected to the suction line (12) in a suction-air-conducting manner in dry mode, and the membrane suction end portion (106) being bypassed in a suction-air-conducting manner and/or not being connected in a suction-air-conducting manner for aspirating the cleaning liquid in rinsing mode.

12. The particle collecting device according to claim 1,
wherein
the particle collecting device (1) comprises control means (107) configured to the effect that:
in rinsing mode, the valve (104) is switched to the fluid-blocking state and the cleaning liquid can be aspirated from the liquid storage unit (102) through the suction line (12) for rinsing the particle collecting device (1); and
in dry mode, the valve (104) is switched to the fluid-conducting state and the suction line (12) can aspirate air through the membrane suction end portion (106).

13. A cleaning method for cleaning a particle collecting device (1) for collecting particles from surfaces for a particle analysis when testing the technical cleanliness of test objects, in particular work pieces, machines and/or printed circuit boards, the cleaning method comprising the following steps:
bringing a cleaning unit (101) into operative contact with the particle collecting device (1);
rinsing a suction line (12) and a particle collection unit (120) with the cleaning liquid in a rinsing mode.

14. The cleaning method according to claim 13,
further comprising
rinsing a centrifugal separator (11) and/or a filter holder (25) with the cleaning liquid in order to flush out accumulated particles.

15. The cleaning method according to claim 13,
further comprising the following steps:
removing an analysis filter from the filter holder (25);
bringing the suction line (12) into operative contact with a liquid storage unit (102) containing the cleaning liquid;
bringing an adapter unit (103) into operative contact with the centrifugal separator (11) by means of a seat (100) of the centrifugal separator (11);
connecting a free end of a connecting hose (105) to the vacuum source (8) in a fluid-conducting manner, the other end of the connecting hose (105) ending in the adapter unit (103);
switching a valve (104) disposed in the connecting hose (105) to a fluid-blocking state;
activating a rinsing mode of the particle collecting device (1) for aspirating the cleaning liquid using the suction line (12);
deactivating the rinsing mode;
connecting a membrane suction end portion (106) to the suction line (12);
switching the valve (104) to the fluid-conducting state;
activating the dry mode for suctioning fluid residue out of the particle collecting device (1) and for discharging liquid backed up in the centrifugal separator (11) via the connecting hose (105);
deactivating the dry mode.

16. The particle collecting device according to claim 1, wherein the test objects comprise work pieces, machines and/or printed circuit boards.

17. The particle collecting device according to claim 1, wherein the cleaning unit (101) is configured in such a manner that the suction line (12) and the particle collection unit (120) can be rinsed in the rinsing mode.

18. The particle collecting device according to claim 3, wherein the seat (100) comprises a threaded connection (52).

19. The particle collecting device according to claim 12, wherein, in the rinsing mode, the cleaning liquid can be aspirated through the suction line (12) for rinsing the modules transporting the particle/air mixture.

20. The particle collecting device according to claim 19, wherein the modules for transporting the particle/air mixture comprise the suction line (12), the centrifugal separator (11), the immersion tube (22), the vacuum supply line (9) and/or the filter holder (25).
